(19) United States
(12) Patent Application Publication
(10) Pub. No.: US 2009/0113838 A1
(43) Pub. Date: May 7, 2009

(54) Structural boards having integrated water drainage channels

(76) Inventors: Fritz G. Paulsen, (US); John D. Benson, (US)

Correspondence Address: Terry B. McDaniel;McDaniel IP Law LLC, 8309 Dye Markers Ridge, North Charleston, SC, 29418, US

(21) Appl. No.: 12/290,530

(22) Filed: Oct. 31, 2008

Related U.S. Application Data
(60) Provisional application No. 60/984,764, filed on Nov. 2, 2007.

(51) Int. Cl. E04B 2/02; B32B 3/00

(52) U.S. Cl. 52/653.1; 428/195.1; 428/211.1

(57) ABSTRACT

A water resistant structural board suitable for use in a wall system is disclosed. The structural board has water drainage channels on at least one of its surfaces to drain any water trapped behind the sealed wall system. The water drainage channels may be imparted into the structural board during or applied subsequent to a board production process, and the produced board is shipped to the construction site for a wall installation. When desired, the channeled surface of the structural board may be laminated, coated, or sprayed with a water resistant layer to further enhance the water resistant property of the board. A wall system including the disclosed structural board does not require a layer-by-layer installation of a component having water resistant property and a component having water drainage channel structure at a work site; therefore, labor cost and installation time may be reduced significantly. Examples of structural boards are oriented strand board, plywood, particle board, oriented strand lumber, dimensional lumber, fiberboard, wafer board, chipboard, laminated veneer lumber, and any substantially equivalent wood composite board known in art.

This application refers to and relies on the provisional U.S. Patent Application No. 60/984,764 filled on Nov. 2, 2007.

### BACKGROUND OF THE INVENTION

Wood is a common structural material that has been used for thousands of years for building purposes. Even today, after the development of several new types of composite materials, wood remains one of the most widely used structural materials because of its excellent strength and stiffness, pleasing aesthetics, good insulation properties and easy workability. Wood-constructed building walls, however, typically suffer from water damage caused by unwanted water trapped behind the sealed wall. The unwanted water usually comes from leakage around doors or windows by virtue of inadequate or cracked sealant around the doors or windows permitting leaking, from cracks in the decorative and protective exterior finish, or from leaks at the top or parapet of the wall. Wind driven rain during severe storms can exacerbate these conditions leading to severe sheathing degradation in systems which failed to provide a drainage plane for the trapped water. This has been most prevalent in double felted, hard stucco applications where adequate drainage planes were not provided.

FIG. 1 shows a typical wall system (100). Structural board (102) is rested against wall frame and insulating cavity (101), and exterior siding materials (104) are installed over the structural board (102). Often house wrap material (103) is placed between the structural board (102) and exterior siding (104). Structural boards commonly used in the construction industry are oriented strand board (OSB), plywood, exterior gypsum board, laminated chipboard and alternative equivalent wood composite board known in art. These structural boards are designed for short term water exposure during the construction phase and are meant to be covered by additional exterior finishing materials. These materials therefore can be susceptible to longer term water damage by trapped or continued water infiltration into the wall system. House wraps can provide for liquid moisture protection provided the moisture does not find its way behind the house wrap. Improper installation, cut outs, penetrations, wrinkles, etc. can lead to areas in which water can settle. If the degradation rate of the exterior sheathing product exceeds the permeation of the house wrap significant structural damage may result.

One of the most common systems susceptible to this phenomenon is hard stucco finished systems where inadequate drainage plane or poor installation of the double felt layer exist. Such a system is shown in FIG. 2. A double layer of Type D asphalt paper (203) is positioned over the structural board (202) to reduce penetration of liquid water into the interior wall system. Although this provides some level of water penetration protection, intersections of its surface with other wall elements, such as window frames and door frames, and the placement of wall penetration and kick outs, often leave gaps or openings that driving rain can penetrate and get behind the felt layer. Once inside the sealed wall, the water can remain trapped long enough before permeation and diffusion can remove the water provided sufficient driving forces exist. If not, significant damage or rot to the structural board (202) and wall frame (201) may occur.

Several attempts have been made to minimize water damage of structural board and wall framing by incorporating furring strips or components having water drainage channels into the wall system, along with a water barrier layer. Water trapped behind the sealed wall system drains down through water drainage channels by gravitational force to the outside of the wall system.

U.S. Pat. No. 4,309,855 relates to protective drainage devices used for protecting masonry walls from moisture contact and infiltration, and more particularly, to drainage plate systems useful for protecting foundations and basements from contact by ground water and resultant infiltrating of such foundations and basement wall structures. In particular, the patentees teach a polystyrene foam board having a channel structure on one of its surfaces. Covering the channel side of a foam board is a synthetic resin film having very small capillaries extending throughout the film. Additionally, there is a bead pack at the base of the board to convey water from the board to a drain pipe. However, styrene foam is known to have excessive moisture adsorption.

U.S. Pat. No. 4,704,048 discloses a panel assembly for use as a combination drainage and insulation member, primarily on the exterior surface of subterranean walls. The assembly has an insulating board made of rigid, foam polymer having channel structure on one outer surface of the board, and a high modulus fabric that is pervious to water and impervious to soil particles attached to that channeled side of the board. The channel on the board is positioned to allow any trapped water to move toward a drainage pipe that conveys the water away from the wall. The fabric is preferably attached to the foam structure using staples, and the resulting rigid foam is installed onto the structural board at the work site.

U.S. Patent Application No. 2001/0023565 describes an insulation board having an array of elements such as domes, pyramids, or frustums coupled to its top surface to define fluid flow passageways and promote fluid drainage away from a building containing the insulation board. The insulation board and arrayed elements are made of expanded polystyrene foam, which is known for its retention of adsorbed moisture.

U.S. Pat. No. 6,410,118 discloses a wall system having a water management system and synthetic stucco exterior. The wall system includes a water durable cement board, a weather-resistive barrier, a basecoat and an exterior stucco finish. The cement board forms the exterior cladding of the building structure, and the basecoat and the exterior stucco finish are applied to the outer surface of the cement board. The interior side of the cement board is textured to form a plane that allows any penetrating water to collect along the textures and drain down the interstitial spaces created by the textures to the outside of the wall cladding. Like other known arts, the exterior wall assembly must be affixed to the structural board such as plywood or OSB board that was adhered to the wall frame. Several layer-by-layer steps are required to install the wall system using various adhesion methods such as adhesive, stapling, nailing, and other mechanical and bonding equivalents. As a result, such a wall system demands significantly high labor cost and installation time at the work site.

U.S. Pat. No. 6,990,775 discloses a corrugated sheet material adapted to allow drainage of moisture from a wall system having a plurality of ridges and grooves on opposite sides of the sheet of corrugated material. The corrugated sheet material has a multiplicity of perforations and is relatively inflexible under a force applied generally perpendicular to the sheet. A sheet of water permeable material is affixed to one side of the corrugated sheet material by construction adhesives. The corrugated sheet material is placed over the exterior surface of the structural board with the ridges and grooves being oriented in a vertical direction. An exterior finish is then placed over the exterior surface of the corrugated sheet.

U.S. 2002/0108333 discloses a wall and roof drainage apparatus, method, and tool. A method is taught of a moisture-draining exterior surface construction comprising the steps of: a) fastening a plurality of wood panels to the outward-facing sides of wooden structural members; b) fastening a plurality of moisture drainage panels, taken from the group of i) shredded hydrophobic moisture drainage panels and ii) sheet moisture drainage panels, to the outward-facing sides of the wood panels; c) fastening a lath to the outward-facing sides of the moisture drainage panels; and d) applying a surface composition to the lath.

Unfortunately, these known wall systems require intensive labor and installation time at the work site, since each component of the wall systems must be installed layer-by-layer. In addition to the common layer-by-layer installation of a wall system, a component having water drainage structure typically must be installed as another layer to the wall system at the work site.

Accordingly, there is substantial demand in the building and construction industry for a wall system that has excellent water resistance and improved ability to drain any trapped water inside a sealed building wall structure, but also with enhanced ease of installation that minimizes labor cost and time incurred to install such wall systems at the work site. This resistance is desired during both the construction phase and over the service life of the wall construction.

Furthermore, it is beneficial to have a water resistant structural board with channel structures on its surface(s) to drain trapped water from the sealed wall that does not demand additional layer-by-layer assembly steps during a wall installation. Known wall systems with water drainage features require separate and additional installations, from the typical wall systems, of a water resistant layer and a component with water drainage ability. Having a structural board with excellent water resistant and trapped water drainage will significantly reduce laboring cost and time installation at the construction site.

### SUMMARY OF THE DISCLOSURE

The present disclosure relates to a water resistant structural board suitable for use in a wall system, having water drainage channels on at least one of its surfaces to drain any trapped water behind the sealed wall system. The water drainage channels may be imparted into the structural board during or post board production process, and the produced board is shipped to the construction site for a wall installation. When desired, the disclosed water resistant layer may be positioned on the surface of channeled structure to further enhance the water resistant property of the structural board. The wall system including the disclosed structural board does not require additional layer-by-layer installation of a component having water resistant property and a component having water drainage channels at a work site; therefore, labor cost and installation time may be reduced significantly. Examples of structural boards of the invention (i.e., having integrated water drainage channels) include oriented strand board, plywood, particle board, oriented strand lumber, dimensional lumber, fiberboard, wafer board, chipboard, laminated veneer lumber, and any substantially equivalent wood composite boards known in art.

### BRIEF DESCRIPTION OF THE DRAWINGS

FIG. 1 is a schematic illustration showing a typical wall system (100) having wall frame and insulation cavity (101), structural board (102), house wrap (104), and exterior finish (103).

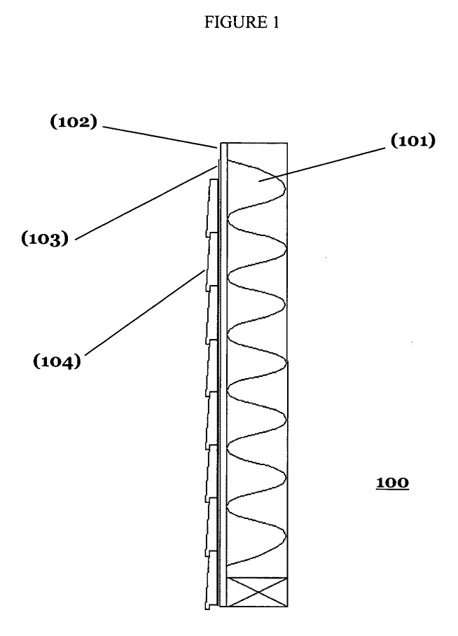

FIG. 2 is a schematic illustration showing a hard stucco type wall system (200) having wall frame and insulation cavity (201), structural board (typically OSB or Plywood) (202), asphalt paper (typically two layers of Type D) (203), and an exterior finish system (stucco coat) (204).

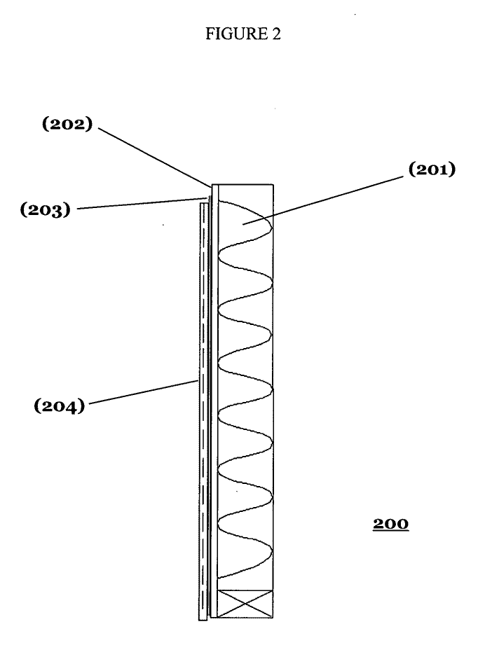

FIG. 3 is a schematic cross section illustration showing one embodiment of the disclosed structural board wherein the structural board has a channel structure on one of its outer surfaces.

FIG. 4 is a schematic cross section illustration showing one embodiment of the disclosed structural board wherein a channeled surface of the structural board contains a laminated, coated, or sprayed water resistant layer.

FIG. 5 is a schematic illustration showing one embodiment of the disclosed wall system wherein the structural board has a channel structure on one of its outer surfaces and is placed behind a stucco exterior finish system.

FIG. 6 is a schematic illustration showing one embodiment of the disclosed wall system wherein the structural board has channel structure on both of its outer surfaces.

FIG. 7 is a schematic illustration showing one embodiment of the disclosed wall system wherein the structural board has a two dimensional channeling structure on one of its outer surfaces characterized by formed (by pressing or other means) circular, three dimensional hemi-spherical extensions extending above the surface level of the structural board to allow for horizontal or vertical installation.

### DETAILED DESCRIPTION OF THE DISCLOSURE

The following detailed description illustrates embodiments of the present disclosure; it is not, however, intended to limit the scope of the appended claims in any manner.

A water resistant structural board of the present disclosure comprises a top edge, a bottom edge, and two opposite outer surfaces, wherein at least one of the outer surfaces of the structural board has water drainage channels. When desired, both outer surfaces of the water resistant structural board may have water drainage channels.

Structural boards suitable for use in the present disclosure may be made of any known composite boards. These include, but are not limited to, oriented strand board, plywood, particle board, oriented strand lumber, dimensional lumber, fiberboard, wafer board, chipboard, laminated veneer lumber, and any substantially equivalent wood composite board known in art.

As used herein, “wood” is intended to mean a cellular structure, having cell walls composed of cellulose and hemicellulose fibers bonded together by lignin polymer. It should further be noted that the term “wood” encompasses lignocellulosic material generally.

By “wood composite material” it is meant a composite material that comprises wood and one or more wood composite additives, such as adhesives or waxes. The wood is typically in the form of veneers, flakes, strands, wafers, particles, and chips. Non-limiting examples of wood composite materials include oriented strand board (“OSB”), waferboard, particle board, chipboard, medium-density fiberboard, plywood, parallel strand lumber, LVL, PSL, OSL LSL, and structural composite lumber (“SCL”). Common characteristic of the wood composite materials are that they are composite materials comprised of strands and ply veneers bonded with polymeric resin and other special additives. As used herein, “flakes”, “strands”, “chips”, “particles”, and “wafers” are considered equivalent to one another and are used interchangeably. A non-exclusive description of wood composite materials may be found in the Supplement Volume to the Kirk-Rothmer Encyclopedia of Chemical Technology, pp 765-810, 6.sup.th Edition.

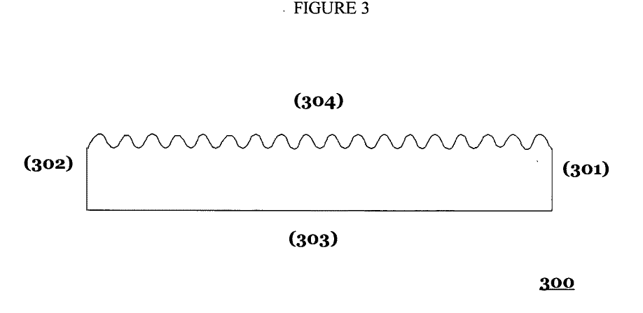

FIG. 3 shows one embodiment of the structural board of the present disclosure. The structural board (300) has a top edge (301), a bottom edge (302), and two surfaces (303 and 304), wherein the outer surface (304) has water drainage channels. The drainage channels may be imparted to the structural board during the board production process such as at a pressing operation, during or subsequent to board formation. The disclosed board having channeled surface (300) may be produced at a board manufacturing site during board manufacture or off-site post board manufacture and shipped to a construction site for an installation of a wall system. At the work site, the disclosed board may be incorporated into the wall system using any conventional wall assembly process, without any additional step of a layer-by-layer installation that is commonly necessary in order to impart water drainage channels using known arts.

The channel structure on the surface of the disclosed structural board is to enhance the drainage of the water trapped in the sealed wall by allowing it to flow downward through channels by gravity force and drain outside the wall system. A variety of channel structures are suitable for the present invention. These include, but are not limited to, horizontal channels, vertical channels, and cross-diagonal channels. It is to be understood that any other textured patterns or non-patterned, irregular relief formations that create interstitial spaces for the unblocked gravitational flow of water may be used in the presently disclosed invention.

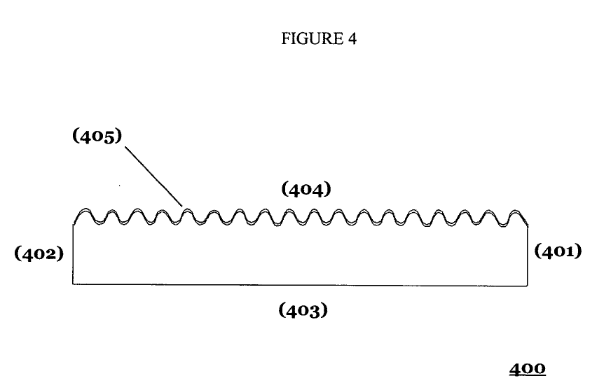

When desired, the surface of channeling structures on the disclosed board may be laminated, coated, or sprayed with a water resistant layer to further enhance the water resistance of the board, as shown in FIG. 4. The structural board (400) has a top edge (401), a bottom edge (402), and two surfaces (403 and 404), wherein the surface (404) has water drainage channels. The channeled surface (404) is laminated, coated, or sprayed with a water resistant layer (405). The lamination process may be performed during the production process of the structural board and the formation of channels on the board surface, such as during a press operation process. The structural board (400) may be produced at a board manufacturing site and shipped to a construction site for an installation of a wall system. Water channel formation and lamination may also occur as a post panel production operation where as finished panels are feed through appropriate laminating and embossing equipment. Coating or spraying operations may also be completed in-line, off-line, or even at the work site as needed. At the work site, the disclosed board may be incorporated into the wall system using any conventional wall assembly process, without any additional step of the layer-by-layer installation that is commonly necessary in order to impart water drainage performance using known arts.

The water resistant layer suitable for use in the present disclosure include, but are not limited to, cellulosic-based paper such as kraft paper and extensible kraft paper, non-woven fabric, woven fabric, spun-bond thermoplastic polymer such as polyethylene, nylon, polypropylene, emulsified or solvent-based coatings or sprays, and combinations thereof.

The water resistant laminated layer structure may be impregnated with thermoplastic or thermoset resins to create or add formation stability and hydrophobic character. Examples of resins suitable for use in the present disclosure include, but are not limited to, phenolic resin, rosin-based resin, melamine resin, tie-layer thermoplastic, hot melt adhesive, polymeric emulsion-based adhesive, isocyanate based resins and combinations thereof.

In one embodiment of the present disclosure, the wall system includes:
(a) a wall frame;
(b) a water resistant structural board comprising a board substrate having a top edge, a bottom edge, and two opposite outer surfaces, wherein at least one of the outer surfaces has water drainage channels; and
(c) an exterior finish.

In one embodiment of the present disclosure, the wall system includes:
(a) a wall frame;
(b) a water resistant structural board comprising a board substrate having a top edge, a bottom edge, and two opposite outer surfaces, wherein at least one of the outer surfaces has water drainage channels;
(c) an insulation board; and
(d) an exterior finish.

When desired, the disclosed structural board having its channeled surface laminated, coated, or sprayed with a water resistant layer may be used as a water resistant structural board to further enhance the water resistant performance.

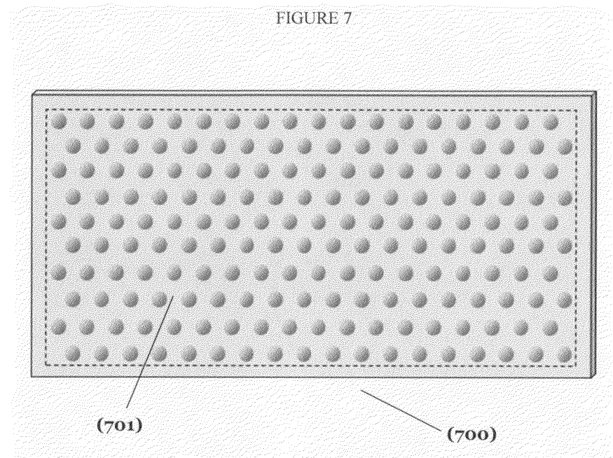

Panels incorporating a two dimensional design as that shown in FIG. 7 can be applied to the walls in horizontal or vertical configurations. Panels shown in FIGS. 4 and 7 once applied to the wall frame can have the joints sealed by a variety of techniques known to the art such as incorporating ship lap or tongue and grove joints, or joint tapping systems like the one available from Huber Engineered Woods marketed under the trade name ZIP System™ tape, provided the thickness of the tape is less than the height differences of water drainage channels so as to not to create a dam within the wall. Recent art, such as spray sealant systems available from Sto Corporation marketed under StoGuard™ sprayable barrier brand may also be applied to seal the seams. Sprayable barrier systems may also provide complete joint and exposed surface barrier protection over textured panels in lieu of a water resistant laminated barrier where only the water channels have been supplied to produce a water resilient exterior surface ready to apply exterior surface finish materials, i.e., plank siding, stucco, veneers, etc. This provides for a labor savings by integrating the drainage patterns into the structural panel board versus a layer by layer approach. Sprayable barrier coatings represent a plausible solution where installation of traditional house wraps or building felts using traditional methods over a heavily textured panel (300) of FIG. 3 would be nearly impossible.

Various exterior finishes may be used in the present disclosure. These include, but are not limited to, concrete block, brick, natural or man-made stone, and wood siding of all types including wooden lap siding, wood-appearing concrete and fiber lap siding, stucco, stucco-look finish such as exterior insulation and finish systems (EIFS), and the stucco-look finish applied directly over the exterior finish systems (DEFS).

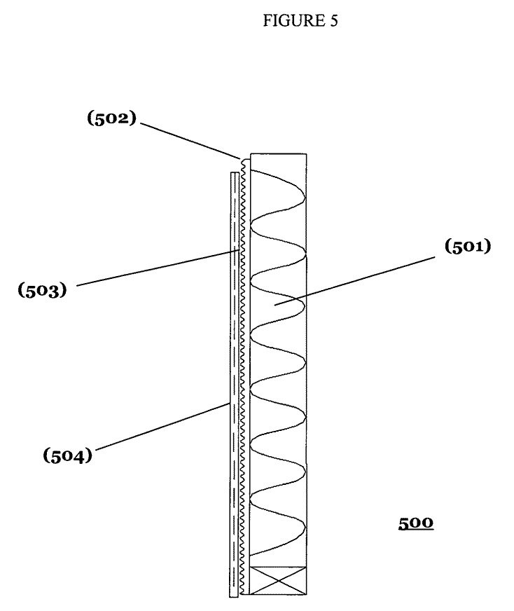

FIG. 5 shows one embodiment of the wall system (500) of the present disclosure. The water resistant structural board with integrated channels (502) rests upon an interior wall frame (501) of the building such that its surface without channel structure is against the wall frame. The wall exterior stucco finish system (504) is then affixed to the structural board against the channeled side of the board to create a drainage medium air gap (503) between the channeled surface of the structural board (502) and the inner surface of the exterior finish system (504) for draining the water away from the building structure. Addition of a double felt layer is not required, nor is additional layer by layer buildup of separate water channels, furring strips, or air gaps to facilitate drainage representing a significant labor savings. When desired or necessary, an interior insulation board may be positioned between the structural board (502) and the exterior finish system (504).

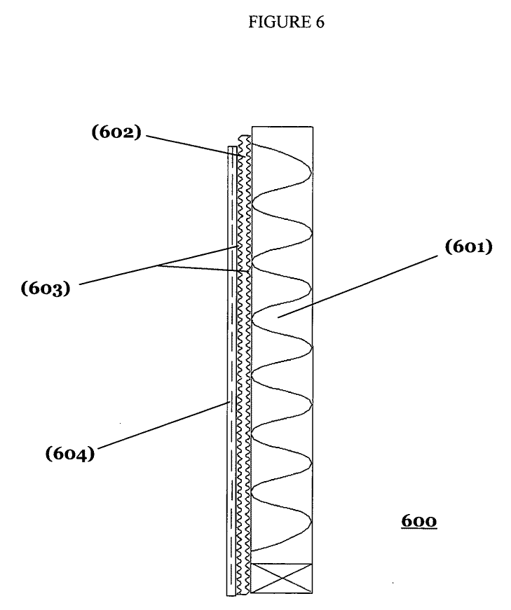

FIG. 6 shows one embodiment of the wall system (600) of the present disclosure. The water resistant structural board can have water channels imparted on both sides of the panel surface (602) and rest upon an interior wall frame (601). The exterior finish (604) is then affixed to the structural board (602). Panel provides for liquid water drainage from both sides (603) of the exterior sheathing under potential situations where the dew point is reached inside the wall cavity and water vapor permeating through the structure condenses internally. When desired, an interior insulation board may be positioned between the structural board (602) and the exterior finish (604).

FIG. 7 is a schematic illustration showing one embodiment of the disclosed wall system (700) wherein the structural board has a two dimensional channeling structure (701) on one of its outer surfaces characterized by formed (by pressing or other means) circular, three dimensional hemi-spherical extensions extending above the surface level of the structural board to allow for horizontal or vertical installation. The raised circular surfaces permit drainage without forced routing within a particular channel, so gravity truly determines water routing and avoids any alignment requirements between upper and lower construction boards to allow proper drainage.

### EXAMPLE 1

A specialized water-resistant release barrier coated kraft paper is treated on the opposite side to the release barrier coating with an adhesive resin compatible with OSB bonding systems, for example phenolic-formaldehyde based adhesive bonding resins available from Georgia-Pacific Resins under the trademark RESI-LAM® laminating resin. A pressing plate imparting the grooved pattern shown in FIG. 4 is utilized. Sheet is bonded to the panel simultaneously during the heating OSB pressing process resulting in a textured surface with about a peak to valley difference of 50 mils. Thus, creating a three dimensional channel in which water trapped or forced from wind driven rain or other means behind the finished building siding material (i.e. vinyl or wood siding, stone veneer, stucco systems, and the like) and has a means for escape via gravity down the wall construction to the foundation level eliminating the potential for water-wood based sheathing product structural degradation resulting from trapped water. Deeper channels can be produced but must be balanced with overall panel density and molding strength of the chosen water resistive barrier.

### EXAMPLE 2

Following the procedure of Example 1 for the lamination of a specialized kraft barrier sheet to an OSB panel, heat pressed laminations are performed utilizing a textured press plate imparting the water drainage channels to various groove depths and designs during the lamination. Deeper channels and extended three dimensional shapes impart higher stresses on the paper component. Higher stresses can lead to barrier failure and compromise the panel system liquid water repellency. When about a 32 mils groove depth is reached using a pattern imparted in that of FIG. 4, the traditional kraft based papers with about less than about 2 to 3% stretch value fail and form large cracks along the direction of the groove. However, when an extensible kraft paper with greater than about 20 to 25% stretch is utilized large cracks were avoided at these deeper groove depths. See FIGS. 3 and 4. Avoiding cracks is important as to maintain the liquid water repellency factor of the specialized release barrier coated kraft. By maintaining the liquid water repellency at these higher groove depths the textured panel product does not require the difficult to impossible task of applying house wrap over a textured surface.

It is to be understood that the foregoing description relates to embodiments that are exemplary and explanatory only and are not restrictive of the invention. Any changes and modifications may be made therein as will be apparent to those skilled in the art. Such variations are to be considered within the scope of the invention as defined in the following claims.

We claim:

1. A structural board, comprising:
a. a top edge;
b. a bottom edge; and
c. two opposite outer surfaces, wherein at least one of the outer surfaces has water drainage channels.

2. The board of claim 1, comprising a member selected from the group consisting of oriented strand board, plywood, particle board, oriented strand lumber, dimensional lumber, fiberboard, wafer board, chipboard, laminated veneer lumber, composite board, and combinations thereof.

3. The board of claim 1, wherein the water drainage channel comprises horizontal channels, vertical channels, cross-diagonal channels, non-patterned or patterned textures, and combinations thereof.

4. The board of claim 1, further comprising a water resistant layer sprayed, coated or laminated on the outer surface of the board having the water drainage channels.

5. The board of claim 4, wherein the laminated water resistant layer comprises a member selected from the group consisting of kraft paper, extensible kraft paper, cellulose-based paper, asphalt paper, non-woven fabric, woven fabric, spun-bond or melt-blown thermoplastic material, polyethylene, nylon, polypropylene, emulsified or solvent-based coatings or sprays and combinations thereof.

6. The board of claim 4, wherein the water resistant layer comprises an extensible kraft paper.

7. The board of claim 4, wherein the water resistant layer comprises a thermoplastic resin.

8. The board of claim 4, wherein the water resistant layer comprises a thermoset resin.

9. The board of claim 4, wherein the water resistant layer comprises a material selected from the group consisting of phenolic resin, epoxy resin, rosin-based resin, melamine resin, isocyanate resins, tie-layer thermoplastic, hot melt adhesive, polymeric emulsion-based coatings, and combinations thereof.

10. A wall system including:
(a) a wall frame;
(b) a water resistant structural board of claim 1; and
(c) an exterior finish.

11. The wall system of claim 10 further including an insulation board.

12. The wall system of claim 10 wherein the exterior finish comprises a material selected from the group consisting of concrete block, brick, natural stone, man-made stone, wooden siding, wood-appearing concrete and fiber lap siding, stucco, stucco-look finish, stucco-look finish applied directly over the exterior finish systems, vinyl or aluminum siding, and combinations thereof.

13. A wall system including:
(a) a wall frame;
(b) a water resistant structural board of claim 4;
(c) an exterior finish.

14. The wall system of claim 13, further including an insulation board.

15. The wall system of claim 13,wherein the exterior finish comprises a material selected from the group consisting of concrete block, brick, natural stone, man-made stone, wooden siding, wood-appearing concrete and fiber lap siding, stucco, stucco-look finish, the stucco-look finish applied directly over the exterior finish systems, vinyl or aluminum siding, and combinations thereof.
